(19) United States
(12) Patent Application Publication
(10) Pub. No.: US 2008/0196609 A1
(43) Pub. Date: Aug. 21, 2008

(54) System and Method for Inkjet Printing

(75) Inventors: Joachim Spies, Copenhagen N (DK); Frederik J. Dynesen, Haslev (DK); Christoffer Bay, Praesto (DK); Teit Nielsen, Roskilde (DK); Allan Sleto, Ringsted (DK); Jan Nymann Weje, Korsor (DK); Hans-Erik Hjelmroth, Korsor (DK); Sten Haunstrup, Roskilde (DK)

Correspondence Address: FITCH EVEN TABIN AND FLANNERY, 120 SOUTH LA SALLE STREET, SUITE 1600, CHICAGO, IL, 60603-3406, US

(73) Assignee: Glunz & Jensen A/S, Ringsted (DK)

(21) Appl. No.: 11/568,098

(22) PCT Filed: May 4, 2005
(86) PCT No.: PCT/DK05/00306

§ 371 Date: Sep. 20, 2007

(30) Foreign Application Priority Data
May 5, 2004 (DK) PA 2004 00724
May 10, 2004 (DK) PA 2004 00743
Sep. 28, 2004 (DK) PA 2004 01471

(51) Int. Cl. B41F 9/01

(52) U.S. Cl. 101/142

(57) ABSTRACT

A system and method for making an image printing plate and for positioning control of a lithographic printing plate in the system. The system includes a carrier plate for supporting the printing plate for thereby increasing image quality, and a controlled curing device for improved accuracy of curing.

### TECHNICAL FIELD

This invention relates to a system and method for making an image printing plate, a lithographic printing plate and to a positioning control of a printing plate in said system.

### BACKGROUND

Lithographic printing has remained a popular method of printing for many years due to the low costs for producing a significant number of prints. Many techniques for improving lithographic printing have therefore emerged such as described in U.S. Pat. No. 5,750,314. This patent discloses a plate, such as aluminium with a grained and anodized hydrophilic surface, coated with a first material, which is soluble in a first solvent, whereupon a second material, which is strongly adherent to the first material and insoluble in the first solvent, is selectively applied to the coated plate by an inkjet printer. The plate is then exposed to the first solvent to establish an image on the plate. The plate may include a surface coating of silicon, and the first material may be a primer, which promotes adhesion of a second material in the form of an oleophilic adhesive which is selectively applied. The primer may then be developed to expose the silicone on the non-image areas of the plate.

Further, European patent no. EP 0 697 282 discloses a process for the manufacture of a lithographic printing plate, which process comprises the steps of: (1) projecting droplets of liquid, e.g. by means of inkjet, onto a receiving material having a hydrophilic surface thus bringing into working relationship on the surface a reducible silver compound (A), a reducing agent (B) for the silver compound and physical development nuclei (C) that catalyze the reduction of the silver; and (2) hydrophobizing the silver image that has been obtained through the first step (1) by overall contacting the printing surface with a hydrophobizing substance for the silver image or by image-wise depositing the hydrophobizing sub-stance on the silver image. The silver image is formed by means of dissolved silver ions that become reduced by the reducing agent in an oxidation-reduction reaction through catalytic action of the physical development nuclei.

The techniques and processes described in the U.S. Pat. No. 5,750,314 and in the European patent no. EP 0 697 282 require liquid processes, which generally cause the processes to complicate.

Further, U.S. Pat. No. 5,738,013 discloses an inkjet fluid containing a transition metal complex, such as chromium complexes of organic acids, as a reactive component. The inkjet fluid is ejected by an inkjet printer head to form an oleophilic, water-insoluble, and durable image on a hydrophilic receiving layer and, subsequently, exposed to an external energy source causing the reaction of the reactive component. The receiving layer is coated with a coating selected in accordance with receptivity to the inkjet fluid, interaction with the reactive component in the inkjet fluid, and the hydrophilic properties and water-fastness properties. The coating material preferably contains polyvinyl alcohol or a copolymer thereof aluminium boehmite, alumina, silicate or silica.

In addition, European patent application no. EP 0 503 621 discloses a concrete structure of a printing plate making apparatus. The plate making apparatus comprises a plate feeding section, an image output section, an image exposure section, a development treatment section, a water washing section, and an after-treatment section. Basically, it is designed to transport the printing plates horizontally from the plate feeding section to the after-treatment section, during which period a predetermined treatment can be made in each treatment section. The image output section is designed to form the ink image on the surface of the printing plate by injecting ink of a predetermined composition to the printing plate. Upon printing, the position of printing plate is controlled by a roll for plate position control during imaging. The image exposure section is designed to irradiate a light suited to the ink composition or material of printing plate. This exposure treatment converts an area where the ink image is not formed to a soluble layer to the developer, while an area where the ink image is formed is made an insoluble area. The development section is designed to supply the developer in accordance with the material of photosensitive layer to the printing plate, and unnecessary photosensitive layer (soluble area) is swelled and/or dissolved. Subsequently, the unnecessary photosensitive layer which was swelled and/or dissolved is mechanically removed. The water washing section is designed to supply washing water to the printing plate, and the developer on the printing plate is washed off. The after-treatment section is designed to supply desensitization liquid to the printing plate, and to remove an excessive desensitization liquid on the printing plate. The drying section is designed to evaporate the solvent component in the desensitization liquid, which is adhered to the surface of the printing plate. However, the apparatus does not provide optimum positioning of the printing plate to resolutions required in state of the art lithographic printing.

### SUMMARY OF THE INVENTION

An object of the present invention is to provide a system for printing of images, especially lithographically, which system provides an increased resolution of the images creating printing plates without the need for liquid processing.

A particular advantage of the present invention is that the system enables greater utilization of the printing plates, since the margins to be used for imaging are significantly reduced. In fact, a zero margin is possible.

A particular feature of the present invention relates to the provision a specially designed carrier plate, having padding on one side, thereby increasing moving control of the printing plate substrate resting on the carrier plate during printing.

The above object, advantage and feature together with numerous other objects, advantages and features, which will become evident from below detailed description, are obtained according to a first aspect of the present invention by a system for printing an image on a printing plate and comprising:

a printing station for printing said image onto a printing plate and comprising a printer head for providing ink adapted to adhere to and interact with said printing plate and transport means for positioning said printer head relative to said printing plate; and

a carrier plate for supporting a printing plate in said printing station and comprising a pattern for interacting with said transport means.

In a preferred embodiment, said printing plate may be a lithographic printing plate. In the following the invention will be described in connection with lithographic printing, however, within the invention idea the printing plate may be used in connection with other printing applications.

The system according to the first aspect of the pre-sent invention operates differently from conventional systems for production of print plates in that no liquid processing is needed. The system is capable of producing an imaged and cured lithographic printing plate ready for off-set printing either in two separate processes or in one continuous process, which is ready for off-set printing of high image quality.

The system according to the first aspect of the pre-sent invention may utilise direct imaging on coated or non-coated printing plates. The system may utilise inkjet printing together with a special ink so as to provide a resolution and registration of the image of the same order as required with normal lithographic printing plates.

The printing plate according to the first aspect of the present invention may comprise a blank or grained surface such as a grained aluminium oxide surface. The grained surface may be coated or uncoated. The grained surface may comprise a water soluble coating providing said printing plate with decreased surface energy. The coating may be a fluorinated material or surfactant, preferably a material or surfactant that does not form hydrophobic or oleophilic areas on the printing plate when heated above 200° C., thereby defining a wetting for receiving droplets of ink from the printer head. The coating may be adapted to dissolve in said droplets of ink. The coating may be solid Zonyl FSA.

When coated the coating may have an activated fluorinated surfactant so as to define a wetting for receiving droplets of ink from the printer head, which surfactant is adapted to dissolve in the droplets of ink. The ink may comprise dye, for instance a Werner complex transition metal dye, adapted to interact with the surfactant and form a layer of spots on the printing plate when heated. The combination of surfactants in the coating and transition metal dye in the ink provides excellent means for achieving a well-defined wetting of the printing plate. The ink may in preferred embodiments comprise a polymer and also comprise a polymer which comprises transition metals bonded to the polymer.

Alternatively, the coating may comprise a hard soap, such as metal soap based on sodium, having a pH in the range between 7 and 10. The coating ensures a semi-durable printing surface on which an inkjet printer accurately may print an image without bleeding. The coating may belong to a group of materials having time-dependent wetting from fast extended wetting to dwelling i.e. only wetting on the area of the impact of the droplet. This coating comprises several advantages: it is environmental friendly; it is able to interact in chemical processes during polymerization or curing; it provides anti-corrosion properties to the printing plate; it protects the surface of the printing plate from fat or oil; or mechanical impact.

Hydrophobic/oleophilic agents in the ink may enter through the coating comprising, e.g., hard soap even when the coating has a larger thickness so as to ensure the droplet of ink does not spread on the printing plate's surface.

The hard soap coating may comprise a plurality of agents for achieving a wide variety of functions. For example, the hard soap coating may comprise softening agents.

The system according to the first aspect thus operates with an add on process rather than an etching process.

The transport means according to the first aspect of the present invention may comprise a carrier arm for carrying the printer head and enabling motion of the printer head in a first direction, and a roller assembly for moving the carrier plate in a second direction perpendicular to the first direction. The roller assembly may comprise at least two rollers. A first roller may be adapted to act on a surface of the carrier plate carrying the printing plate, and a second roller may be adapted to act in cooperation with the first roller on opposite surface of the carrier plate. The first or the second roller may comprise an indented surface corresponding to the pattern of the carrier plate. The cooperation of the second roller and the pattern of the carrier plate provides high positioning accuracy of the carrier plate, and consequently the printing plate thus enables high resolution imaging.

The first or the second roller according to the first aspect of the present invention may be adapted to cut the pattern in the carrier plate with the indented surface.

The printer head according to the first aspect of the present invention may comprise an inkjet printer head. Obviously any printer type may be utilised in the system, however, an inkjet printer head provides imaging without physically contacting the printing plate.

The printing station according to the first aspect of the present invention may further comprise an air fan and/or a diffuser adapted to provide a flow of air removing evaporated liquid, e.g. solvents, from the printing plate between each passing of the printer head.

The air fan and/or diffuser may be adapted to control flow of air proportionally to steam saturated air volume generated by a passing of the printer head. The air fan and/or diffuser may also be adapted to control flow of air as a function of time and amount of flow of ink from the inkjet printer head. The air fan and/or diffuser may be further adapted to provide flow of air having a specific temperature and/or gaseous content. The air fan and/or diffuser provides a significant advance since the creation of “fish eyes” on the printing plate is generally avoided, and in addition the air fan and/or diffuser may, when using uncoated grained surface, provide a hot airflow to preliminary bond droplets of ink to the surface.

The carrier plate according to the first aspect of the present invention may comprise a plurality of pads for increasing friction between the carrier plate and the printing plate. The carrier plate may further comprise a plurality of holes for channeling suction of the printing plate onto the carrier plate during printing in the printing station. The plurality of pads provides increased friction between the carrier plate and printing plate thereby securing the printing plate during the printing process and the plurality of holes further secures the printing plate to the carrier plate by channelling suction of the printing plate onto the carrier plate. The suction may be provided by a suction generator cooperating with the transport means. Alternatively, the carrier plate may be configured without pads but comprise indentations that surround the holes and thereby provide cavities between the carrier plate and the printing plate that provide an increased suction force to further secure the printing plate on the carrier plate.

The system according to the first aspect of the pre-sent invention may further comprise a post printing station for curing, cooling, drying and gumming the printing plate, wherein the post printing station comprises a conveyor for transporting the carrier plate supporting the printing plate through a curing zone adapted to cure the printing plate subsequent to printing. Post treatment of the printed printing plate is performed in the post printing station providing a printing plate, which may be used a significant number of times for lithographic printing of images. The printing station and the post printing station are particularly advantageous, since the transport of the printing plate and the printing of the printing plate is performed without physical contact on the printing plate's image surface or grained surface.

The curing zone may comprise a first oven heating the printing plate to a temperature above 120° C. form bonding and/or curing of the droplets to the grained surface. The first oven may comprise a heating lamp assembly for emitting preferably visible light and a reflector for reflecting light emitted from the lamp assembly to the printing plate. The application of visible light provides maximization of transfer of heat to the printing plate's printing surface without great losses to the surrounding air.

In a preferred embodiment the curing zone comprising a first oven may provide temperatures above 150° C., or most preferably above 180° C.

In a preferred embodiment, the post printing station is adapted to control the temperature of the printing plate by controlling the speed of said conveyor, and more preferably to control the speed of said conveyor as a function of a thickness of said printing plate.

The post printing station according to the first aspect of the present invention may further comprise a cooling zone and wherein the conveyor is further adapted to transport the carrier plate supporting the printing plate through the cooling zone adapted to cool the printing plate subsequent to curing of the printing plate.

The post printing station according to the first aspect of the present invention may further comprise a drying zone and wherein the conveyor is further adapted to transport the carrier plate supporting the printing plate through the drying zone adapted to dry the printing plate subsequent to cooling of the printing plate.

The drying zone may comprise a second oven heating the printing plate to a temperature of approximately 50° C., and wherein the second oven comprises a heating lamp assembly for emitting visible light and a reflector for reflecting light emitted from the lamp assembly to the printing plate.

In a preferred embodiment the drying zone may comprise an environment, such as a room, providing the temperature required.

The above objects, advantages and features together with numerous other objects, advantages and features, which will become evident from below detailed description, are obtained according to a second aspect of the present invention by a method for printing an image on a printing plate and comprising:

printing said image by ejecting ink onto a printing plate by means of a printer head and positioning said printer head relative to said printing plate; and

supporting said printing plate by means of a carrier plate comprising a pattern for interacting with said transport means.

In a preferred embodiment, said printing plate may be a lithographic printing plate.

The method according to the second aspect of the present invention may further comprise defining of wetting for received droplets of ink on the printing plate having a surface coated with a coating comprising a surfactant adapted to dissolve in the droplets of ink comprising dye, for instance Werner complex transition metal dye, adapted to interact with the surfactant and form a layer of spots on the printing plate when heated.

The printing according to the second aspect of the present invention may comprise positioning of the carrier plate supporting the printing plate by transport means. The printing may further comprise removing evaporated liquid, e.g. solvents, from the printing plate between each passing of the printer head. The removal may in a preferred embodiment be is controlled in accordance with the flow of ink. The printing further comprises channeling suction of the printing plate onto the carrier plate.

The method according to the second aspect of the present invention may further comprise curing, cooling, drying and gumming the printing plate by means of a post printing station comprising a conveyor for transporting the carrier plate supporting the printing plate through a curing zone adapted to cure the printing plate subsequent to printing.

The curing may comprise heating the printing plate to a temperature above 120° C. to form bonding of the droplets to the surface of the printing plate by means of a first oven, the cooling may comprise cooling of the printing plate subsequent to curing of the printing plate, and the drying may comprise drying of the printing plate subsequent to cooling of the printing plate by means of a second oven.

In a preferred embodiment the curing zone comprising a first oven may provide temperatures above 150° C., or most preferably above 180° C. The method according to the second aspect of the present invention may further incorporate any features of the system according to the first aspect of the present invention.

The above objects, advantages and features together with numerous other objects, advantages and features, which will become evident from below detailed description, are obtained according to a third aspect of the present invention by a carrier plate for supporting a printing plate in a system for printing an image on a lithographic printing plate, and comprising a pattern for interacting with transport means of a printing station of said system.

The carrier plate ensures secure positioning of the printing plate in the printing and post printing stations of the system. Hence improved resolution of images may be achieved.

The carrier plate according to the third aspect of the present invention may incorporate any features of the system according to the first aspect and the method according to the second aspect of the present invention.

The above objects, advantages and features together with numerous other objects, advantages and features, which will become evident from below detailed description, are obtained according to a fourth aspect of the present invention by a printing plate for receiving droplets of ink from a printer head and comprising a printing surface having an hard soap coating.

The coating according to the fourth aspect of the present invention may comprise metal soap, which preferably may be based on sodium.

The printing plate according to the fourth aspect of the present invention may incorporate any features of the system according to the first aspect, the method according to the second aspect of the present invention, and the carrier plate according to the third aspect of the present invention.

The above objects, advantages and features together with numerous other objects, advantages and features, which will become evident from below detailed description, are obtained according to a fifth aspect of the present invention by a substrate for receiving liquid materials in detailed pattern and comprising a coating of soap.

The term “substrate” should in this context be construed as a plate adapted to receive a coating.

The substrate according to the fifth aspect of the present invention may be adapted to receive droplets from an inkjet printer.

The substrate according to the fifth aspect of the present invention may incorporate any features of the system according to the first aspect, the method according to the second aspect of the present invention, the carrier plate according to the third aspect of the pre-sent invention, and the printing plate according to the fourth aspect of the present invention.

Yet another aspect of the present invention is that of a coated printing plate for receiving liquid ink materials in the form of droplets from an inkjet printer wherein the printing plate is coated with solid Zonyl FSA.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1, shows a carrier plate for carrying a printing plate, which carrier plate is according to a first embodiment of the present invention;

FIG. 2, shows a printing station according to the first embodiment of the present invention;

FIG. 3, shows a post printing station according to the first embodiment of the present invention;

FIG. 4 is a schematically illustrated functional block diagram of a system according to the present invention; and

FIGS. 5a-c are schematically drawn figures of an alternative embodiment of a carrier plate according to the present invention.

### DETAILED DESCRIPTION OF PREFERRED EMBODIMENTS

In the following description of the various embodiments, reference is made to the accompanying figures which form a part hereof, and in which are shown by way of illustration a first embodiment of how the invention may be practiced. It is to be understood that other embodiments may be utilized, and structural and functional modifications may be made without departing from the scope of the present invention.

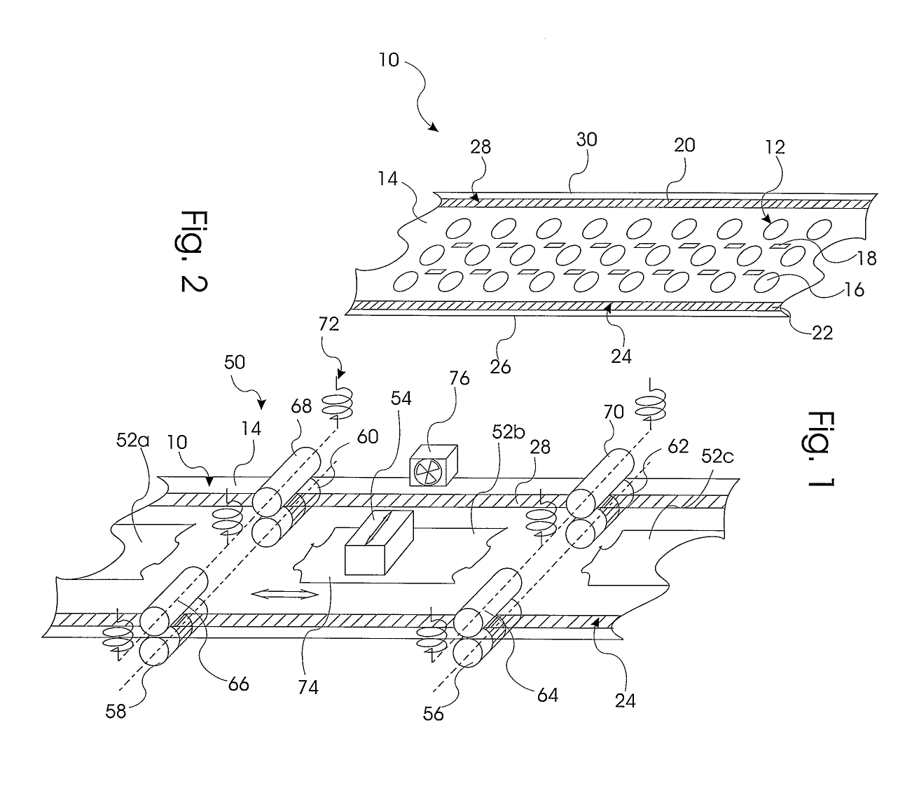

FIG. 1, shows a carrier plate according to a first embodiment of the present invention and designated in entirety by reference numeral 10. The term “carrier plate” is in this context to be construed as a plate for supporting a printing plate or imaging substrate to be used in lithographic printing. The term “printing plate” is in this context to be construed as a substrate to be used in lithographic printing of images.

The carrier plate 10 comprises a plurality of pads 12 on a first surface 14 of the carrier plate 10, which first surface receives and supports the printing plate during the lithographic process. The pads 12 comprise a rubbery surface 16 increasing friction between the first surface 14 of the carrier plate 10 and a printing plate resting on said surface 14. The increased friction secures high manoeuvrability and great positioning capability of the printing plate during a printing section in a printing station such as an inkjet printer.

The carrier plate 10 further comprises a plurality of holes 18, which may be punched in the carrier plate 10 by a stamp or machined in any other appropriate fashion. The plurality of holes 18 provides a channels for providing suction of the printing plate to the carrier plate 10 during a printing process in a printing station.

Finally the carrier plate 10 comprises patterns 20 and 22 on either longitudinal side of the carrier plate 10. The patterns 20 and 22 interact with rolls on the printing station and ensure that the positioning of the carrier plate 10 relative to an inkjet printer head is high resolution controlled, so as to achieve images on the printing plate having an improved resolution. The patterns 20 and 22 comprise a plurality of grooves 24 interacting with the positioning rolls of the printing station. The grooves 24 may be perpendicular to the longitudinal length of the carrier plate 10 or may in fact be slanted relative to the longitudinal length of the carrier plate 10. The grooves 24 on a first longitudinal side 26 of the carrier plate 10 and groves 28 on a second longitudinal side 30 of the carrier plate may be slanted in opposite directions.

The printing plate comprises a grained aluminium oxide surface for receiving ink from an inkjet printer head, which surface is coated with a material of suitable surface tension that may comprise a hard soap, such as metal soap preferably based on sodium, so as to achieve semi-durable surface on which an image may be printed accurately and with no bleeding. A hard soap coating acts as a semi-repellent when a droplet of ink hit its surface, exhibiting time-dependent wetting, which is dependent on the coating materials and the ink. The hard soap coating belongs to a group of materials having a time-dependent wetting between fast extending wetting and dwelling i.e. only wetting the area of the impact of the droplet of ink.

The (hard soap) coating has a selected thickness so as to obtain a well defined and durable spot as a result of penetration of the coating by the active agents in the ink binding to the printing plate.

The hard soap coating is water-soluble and may be washed off areas not covered by spots. Further a metal soap coating is able to withstand temperatures above 200° C. without forming hydrophobic and oleophobic spots. The droplets of ink comprise agents interacting with the coating and forming stable materials at elevated temperatures.

Alternatively, the printing plate comprises a grained aluminium oxide surface for receiving ink from an inkjet printer head, which surface is coated with a coating comprising a surfactant, so as to achieve a well-defined wetting ideal for receiving droplets of ink dissolving the surfactant in the liquid of the droplets of ink. As the printing plate is heated the surfactant interacts with Werner-complexes in the droplets of the ink to form a dye-complex that, when heated above 150° C., form bonding of the droplets to the grained aluminium oxide surface. The printing plate should thus be heated above 150° C., preferably above 200° C., or even more preferably between 205° C. and 215° C.

Hence the printing process of the printing plate comprises confining droplets of ink and forming a hydrophobic/oleophilic layer of spots through a chemical process of interaction of a Werner complex transition metal dye with the surfactant of the coating. This is achieved by curing at elevated temperatures during de-hydration of the spots.

The hydrophobic/oleophilic layer of spots forming internal bonds is a result of water free reactions in at least one type of solvent of activated transition metal salts and carboxylic acid groups.

For example, the grained aluminium oxide surface is coated with (activated) fluorinated surfactants, such as (protonized) Zonyl FSA, or any chemical having a carboxylic acid part, and the droplets of ink containing (activated) material, e.g. chromium.

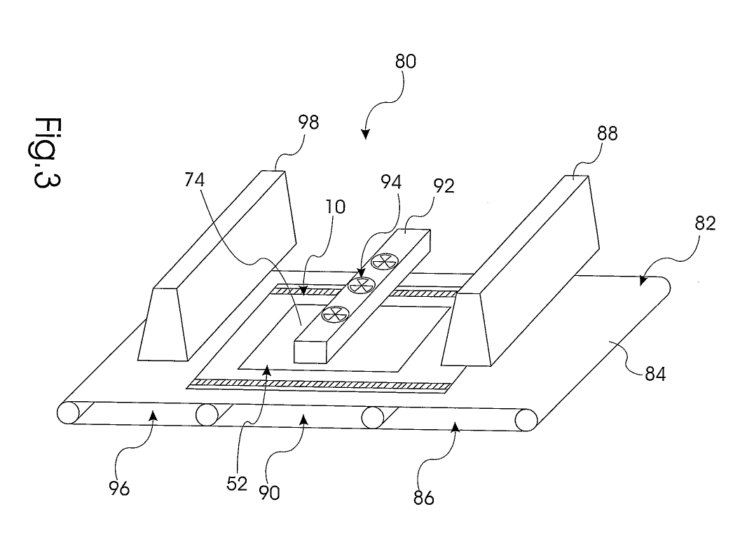

Alternatively, the grained aluminium oxide surface is not coated with a surfactant, however in this case, the ink is compensated for this, and the air fan, to be described with reference to FIG. 2 having reference numeral 76, provides a heated airflow for achieving a preliminary bonding.

In one form, the components are characterized as a result of an aim of a water free reactions in at least one type of solvent of activated transition metal salts and carboxylic acid groups. A particular form of component is as a part of a dye, fluorinated protonated chemicals or any chemical that has a carboxylic acid part, and parts that form a hydrophilic part when reacting with the printing plate, and is able to endured printing colour pick-up and printing.

Alternatively, the ink comprises a polymer dissolved in water and at least one solvent that may incorporate at least one dye and the polymer may comprise bonds between active sites of said polymer and transition metal, preferably chromium(III).

FIG. 2, shows a printing station according to the first embodiment of the present invention and designated in entirety by reference numeral 50. The carrier plate 10 supports a printing plate 52, shown in FIG. 2 as cut sections a, b and c. The printing plate 52 rests securely on the first surface 14 of the carrier plate 10 maintained in position by the suction through the plurality of holes 18 and the plurality of pads 16.

When the printing plate is placed onto the carrier plate, means for positioning, such as wheels, lifts and moves the printing plate into alignment with the carrier plate. For instance, the carrier plate may comprise projecting edges against which the edges of the printing plate get supported and thereby its proper alignment.

In a secured position the printing surface receives droplets from a printer head 54, which may be an inkjet printer head. The printer head 54 may move in a transversal direction relative to the carrier plate 10 thereby achieving a two dimensional printing means. The plurality of grooves 24 and 28 interacts with rolls 56, 58, 60 and 62 thereby enables accurate positioning of the printing plate 52, so as to achieve high resolution imaging of the printing plate 52. Rolls 64, 66, 68 and 70 act on the carrier plate 10 and therefore fixate the printing plate 52 further in place. The rolls 64, 66, 68 and 70 keep a constant pressure on the carrier plate 10 by means of spring elements 72 exerting a downward force on the rolls 64, 66, 68 and 70.

The printing plate 52, having a printing surface 74, may comprise a wide variety of sizes. In fact the printing plate 52 may range from the size of one page (1 p.: standard page print format) to a very large format (VLF: 1.5 times 2 metres).

It is a particular advantage of the printing station 50 that the printing surface 74, being supported by the carrier plate 10, is not exposed to mechanical stresses by the positioning means of the printing station 50. Hence the printing surface 74 may, firstly, receive images on the full surface 74, and, secondly, the risk of damaging the printed image on the printing surface 74 is removed or at least diminished.

The plurality of grooves 24 and 28 may be cut by the rolls 56, 58, 60 and 62 exerting an upward force in cooperation with the rolls 64, 66, 68 and 70 on the carrier plate 10.

The printing station 50 further comprises an air fan 76 for providing a sufficient flow of air to remove evaporated solvents from the printing plate 52 between each passing of the printer head 54. It has been found that this flow of air improves the homogeneity of drying of the high density areas thereby avoiding the formation of irregularities in the image. In general sufficient airflow is required in order to avoid artefacts for example the creation of “fish eyes” orange peel on the printing plate surface 74 of the printing plate 52. The amount of airflow needed to dry the ink is proportional to the volume, which is saturated by vapour, from a single passing of the printing printer head 54, if all the ink was evaporated.

This amount depends on the temperature and the vapour pressure at that temperature. As it takes time to evaporate to saturation it is recommended to use 10-100 times more airflow that theoretically needed.

For example, when using a methyl lactate ink having a partial steam pressure equal to 0.3 kPa at 20° C. results in a lower airflow rate than when using Dowanol PM (1-methoxy-2-Propanol) having a partial steam pressure equal to 2.4 kPa at 20° C. Thus the required airflow may comprise values in the range between 0.04 litres to 0.5 litres per passage of the printer head.

The air fan 76 thus cooperates with the printer head 54 so as to optimized the printing process. The airflow from the air fan 76 may further provide an airflow of a specific temperature or may comprise specific gaseous components. The air fan 76 may generate an airflow in either direction, that is, generate a blowing or a sucking airflow relative to the printing plate. Further the air fan 76 may comprise an output filter for cleaning the airflow before outputting the air to the surroundings. The filter may be carbon-based filter.

The plurality of holes 18 in the carrier plate 10 may further operate as a conduit for transferring a specific temperature to the printing plate 52.

FIG. 3 shows a post printing station according to the first embodiment of the present invention and designated in entirety by reference numeral 80. The post printing 80 comprises a conveyer belt 82 for driving the carrier plate 10 supporting the printing plate 52 through a series of post treatments.

The carrier plate 10 with the printing plate 52 is received at the first end 84 of the conveyer belt 82 and driven through a curing zone 86 in which the printing plate 52 is cured. The curing zone 86 comprises a first oven 88 heating the printing surface 74 of the printing plate 52 using visible light.

The light is generated in the oven 88 by a lamp assembly emitting visible light and a reflector for reflecting light emitted from the lamp assembly to the printing surface 74. Thus the printing surface 74 is cured at a temperature of approximately 200° C. by direct and indirect radiation heat. The temperature is controlled by the speed of the conveyer belt 82, but may obviously be controlled by the light intensity or number of lamps in the lamp assembly and reflectors in the curing zone. One factor, on which the temperature behaviour of the printing plate depends, is the thickness of the printing plate. Therefore, the thickness of the printing plate may be used as a parameter to adjust the speed of the conveyor of the curing device.

The lamp assembly may comprise any visible light sources such as a halogen, infrared lamp, or any combination thereof, for providing radiation heat to the printing surface 74. The spectrum of the light emitted from the lamp assembly may be adjusted to the actual type of printing plate. The radiation heat is maximized, so as to transfer as much heat to the printing surface and not to the surrounding air under the lamp assembly.

Using visible light for generating radiation heat is particularly advantageous since the oven 88 has a fast response time to changes. Further, expensive light sources are avoided, since the printing plate is insensitive to the visible light making the printing process much simpler.

The spectra of the light sources may also incorporate infra-red or ultra violet (UV) spectra, the lamps selected to have a spectrum that is suitable for use with the actual type of printing plate.

Next to the curing zone 86 a cooling zone 90 may reside. The cooling zone 90 comprises a controllable air cooling system 92 comprising one or more air fans 94.

Finally the printing plate 52 reaches a drying zone 96 for drying the printing surface 74 of the printing plate 52 so as to prepare the printing plate 52 for lithographic printing. The drying zone 96 comprises a second oven 98 similarly to the first oven 88 providing a temperature on the printing surface 74 by visible light to approximately 50° C. The second oven 98 is controlled in cooperation with the controlling of the first oven 88 and the controllable air cooling system 92.

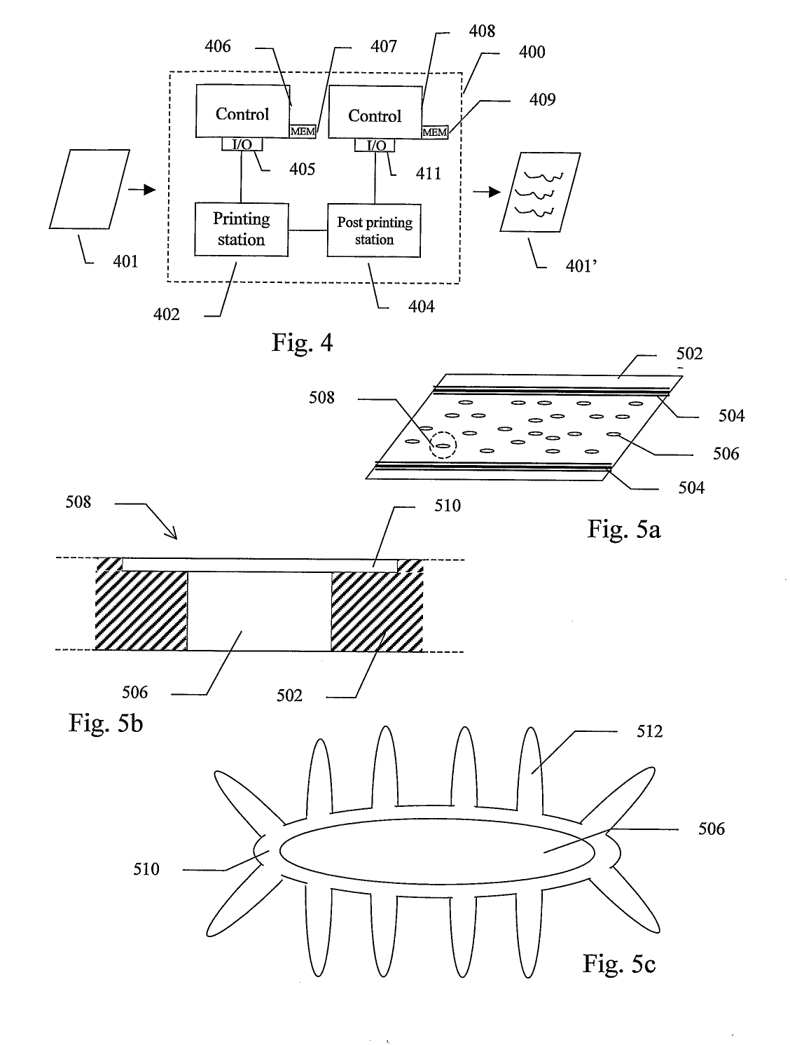

FIG. 4 is a schematically drawn block diagram that illustrates the functional relationship between different components of a system 400 according to the present invention, such as the embodiments described above in connection with FIGS. 1 to 3.

A printing station 402 receives an unprocessed printing plate 401 and processes the plate 401 under control of a first control device 406. The first control device 406 is typically a computer equipped with appropriate communication interfaces 405 and runs under the control of software residing in internal or external memory means 407. The software of the first control device 406 may include raster image processing (RIP) software that converts images and text into bitmap data suitable for output via a printing device such as an inkjet device discussed above. The software of the control device 406 also includes control software for controlling the flow of ink onto the printing plate 401 and also controlling the flow of air that removes evaporated liquid, as described above. The ink flow and air flow is controlled such that they relate to each other, e.g. according to a proportional relationship, which may be predetermined by way of, e.g., manual calibration.

Similarly, a post printing station 404 receives the processed printing plate 401 from the printing station 402 and processes the plate 401 under control of a second control device 408. The second control device 408 is typically a computer equipped with appropriate communication interfaces 411 and runs under the control of software residing in internal or external memory means 409. The software of the second control device 408 includes control software for controlling the speed of the conveyor carrying the printing plate 401 and thereby controlling the temperature of the printing plate 401, as described above. The speed of the conveyor is preferably controlled such that it is a function of the thickness of the printing plate 401, which may be predetermined by way of, e.g., manual calibration. As described above, a processed printing plate 401′ exits the post printing unit after being cured, cooled and dried.

Turning now to FIGS. 5a-c, an alternative embodiment of a carrier plate 502 will be described in some detail. Similar to the carrier plate described above in connection with FIG. 1, the carrier plate 502 in FIG. 5a comprises a plurality of holes 506, which may be punched in the carrier plate 502 by a stamp or machined in any other appropriate fashion. The plurality of holes 506 provides a channels for providing suction of the printing plate to the carrier plate 506 during a printing process in a printing station. Moreover, the carrier plate 502 comprises patterns 504 on either longitudinal side of the carrier plate 502.

Turning now to FIG. 5b, in which a cross sectional view of a detail 508 of an area around one hole 506 is illustrated. In contrast to the previous embodiment described in connection with FIG. 1, the carrier plate 502 is configured without pads but instead comprises indentations 510 that surround the holes 506 and thereby provide cavities between the carrier plate 502 and the printing plate that provide an increased suction force to further secure the printing plate on the carrier plate 502.

An example of a spatial configuration of an indentation 510 is illustrated by way of a view from above in FIG. 5c. The indentation 510 is patterned such that fingers 512 extend from the hole 506. It is to be noted, however, that numerous variations of the “finger pattern” may be utilized.

1. A system for printing an image on a printing plate and comprising:
(a) a printing station for printing said image onto said printing plate and comprising a printer head for providing ink adapted to adhere to and interact with said printing plate and transport means for positioning said printer head relative to said printing plate; and
(b) a carrier plate for supporting a printing plate in said printing station and comprising a pattern for interacting with said transport means; and
wherein said transport means comprises a carrier arm for carrying said printer head and enabling motion of said printer head in a first direction, and a roller assembly for moving said carrier plate in a second direction perpendicular to said first direction.

2. A system according to claim 1, wherein said printing plate is a lithographic printing plate.

3. A system according to claim 2, wherein said printing plate comprises a grained surface, such as a grained aluminium oxide surface.

4. A system according to claim 3, wherein said grained surface comprises a water soluble coating providing said printing plate with decreased surface energy.

5. A system according to claim 1, wherein said ink comprises a dye, adapted to adhere and interact with said coating to form a layer of spots on the printing plate when heated, said ink having low coherence with said coating.

6. A system according to claim 1 wherein said ink comprises a polymer.

7. A system according to claim 6, wherein said ink comprises a polymer which comprises transition metals bonded to the polymer.

8. A system according to claim 1, wherein said roller assembly comprises at least two rollers, a first roller adapted to act on a surface of said carrier plate carrying said printing plate and a second roller adapted to act in cooperation with said first roller on opposite surface of said carrier plate.

9. A system according to claim 8, wherein said first or said second roller comprises an indented surface corresponding to said pattern of said carrier plate.

10. A system according to any of claims 8 or 9, wherein said first or said second roller is adapted to cut said pattern in said carrier plate with said indented surface.

11. A system according to claim 1, wherein said printer head comprises an inkjet printer head.

12. A system according to claim 11, wherein said printing station further comprises an air fan and/or diffuser adapted to provide a flow of air re-moving evaporated liquid from said printing plate between each passing of said printer head.

13. A system according to claim 12, wherein said air fan and/or diffuser is adapted to control flow of air proportionally to steam saturated air volume generated by a passing of said printer head.

14. A system according to claim 12, wherein said air fan and/or diffuser is further adapted to provide flow of air having a specific temperature and/or gaseous content.

15. A system according to claim 12, wherein said air fan and/or diffuser is adapted to control flow of air as a function of time and amount of flow of ink from the inkjet printer head.

16. A system according to claim 1, wherein said carrier plate comprises a plurality of pads for increasing friction between said carrier plate and said printing plate.

17. A system according to claim 1, wherein said carrier plate is homogeneously electrically compensated.

18. A system according to claim 1, wherein said carrier plate comprises holes and/or markings for positioning.

19. A system according to claim 18, wherein said carrier plate comprises a plurality of holes for channeling suction of said printing plate onto said carrier plate during printing in said printing station.

20. A system according to claim 19, wherein said printing station further comprises means for positioning said printing plate.

21. A system according to claim 20, wherein said positioning comprises a first and a second edge alignment.

22. A system according to claim 21, wherein first and second edges are essentially orthogonal.

23. A system according to claim 1, wherein said system further comprises a post printing station for curing, cooling, drying and gumming of said printing plate, wherein said post printing station comprises a conveyor for transporting said carrier plate supporting said printing plate through a curing zone adapted to cure said printing plate subsequent to printing.

24. A system according to claim 23, wherein said curing zone comprises a first oven heating said printing plate to a temperature above 120° C. form bonding and/or curing of the droplets to said grained surface.

25. A system according to claim 23, wherein said curing zone comprises a first oven heating said printing plate to a temperature above 150° C. form bonding and/or curing of the droplets to said grained surface.

26. A system according to claim 23, wherein said curing zone comprises a first oven heating said printing plate to a temperature above 180° C. form bonding and/or curing of the droplets to said grained surface.

27. A system according to claim 24, wherein said first oven comprises a heating lamp assembly for emitting visible light and a reflector for reflecting light emitted from said lamp assembly to said printing plate.

28. A system according to claim 24, wherein said post printing station is adapted to control the temperature of said printing plate by controlling the speed of said conveyor.

29. A system according to claim 28, wherein said post printing station is adapted to control the speed of said conveyor as a function of a thickness of said printing plate.

30. A system according to claim 23, wherein said post printing station further comprises a cooling zone, and wherein said conveyor is further adapted to transport said printing plate through said cooling zone adapted to cool said printing plate subsequent to curing of said printing plate.

31. A system according to claim 30, wherein said post printing station further comprises a drying zone, and wherein said conveyor is further adapted to transport said printing plate through said drying zone adapted to dry said printing plate subsequent to cooling and gumming of said printing plate.

32. A system according to claim 31, wherein said drying zone comprises an environment such as a room/and or a second oven for heating said printing plate to a temperature of approximately 50° C., and wherein said second oven comprises a heating lamp assembly for emitting visible light and a reflector for reflecting light emitted from said lamp assembly to said printing plate.

33. A system according to claim 32, wherein said post printing station further comprises a gumming zone, and wherein said conveyor is further adapted to transport said printing plate through said gumming zone adapted to provide a coating of gummy.

34. A system according to claim 1, wherein said carrier plate is configured to move in a transversal direction.

35. A method for printing an image on a printing plate and comprising:
(a) printing said image by ejecting ink onto a printing plate by means of a printer head and positioning said printer head relative to said printing plate;
(b) supporting said printing plate by means of a carrier plate comprising a pattern for interacting with said transport means;
(c) moving said printer head in a first direction by means of a carrier arm; and
(d) moving said carrier plate in a second direction perpendicular to said first direction by means of a roller assembly.

36. A method according to claim 35, wherein said printing plate is a lithographic printing plate.

37. A method according to claim 35 or 36 further comprising defining wetting for received droplets of ink on said printing plate having a surface coated with a coating comprising a surfactant adapted to dissolve in said droplets of ink comprising a dye, such as for instance Werner complex transition metal dye, adapted to interact with said surfactant and form a layer of spots on the printing plate when heated.

38. A method according to claim 35, wherein said printing comprises positioning said carrier plate supporting said printing plate by transport means.

39. A method according to claim 38, wherein said transport means is configured to cutting grooves in a lateral direction, said grooves being adapted to engage driving means.

40. A method according to claim 39, wherein said printing further comprises removing evaporated liquid from said printing plate between each passing of said printer head.

41. A method according to claim 40, wherein said removal of evaporated liquid is controlled in accordance with the flow of ink.

42. A method according to claim 35, wherein said printing further comprises channeling suction of said printing plate onto said carrier plate.

43. A method according to claim 35, further comprising curing, cooling, drying, and gumming said printing plate by means of a post printing station comprising a conveyor for transporting said printing plate through a curing zone adapted to cure said printing plate subsequent to printing.

44. A method according to claim 43, wherein gumming of said printing plate is excluded if it has not been dried.

45. A method according to claim 43, wherein said curing comprises heating said printing plate to a temperature above 150° C. to form bonding of the droplets to the surface of the plate by means of a first oven.

46. A method according to claim 45, wherein said temperature of said printing plate is controlled by controlling the speed of said conveyor.

47. A method according to claim 46, wherein speed of said conveyor is controlled in accordance with the thickness of said printing plate.

48. A method according to claim 43, wherein said cooling comprises cooling of said printing plate subsequent to curing of said printing plate.

49. A method according to claim 48, wherein said drying comprises drying of said printing plate subsequent to cooling of said printing plate by means of a second oven.

50. A carrier plate for supporting a printing plate in a system according to claim 1; for printing an image on a printing plate, and comprising a pattern for interacting with transport means of a printing station of said system.

51. A carrier plate according to claim 50, wherein said printing plate is a lithographic printing plate.

52. A carrier plate according to claim 50, comprising holes and cavities adapted to provide suction force to secure the printing plate on the carrier plate.

53. A printing plate for receiving droplets of ink from a printer head and comprising a printing surface having a hard soap coating.

54. A printing plate according to claim 53, wherein said hard soap coating comprising a metal soap.

55. A printing plate according to claim 54, wherein said metal soap comprising sodium.

56. A substrate for receiving liquid materials in detailed pattern and comprising a coating of hard soap.

57. A substrate according to claim 56 adapted to receive droplets from an inkjet printer.

58. A coated printing plate for receiving liquid ink materials in the form of droplets from an inkjet printer wherein the printing plate is coated with solid Zonyl FSA.

59. A method according to claim 37, wherein said ink comprises a Werner complex transition metal dye.
